(19) United States
(12) Patent Application Publication
(10) Pub. No.: US 2007/0073579 A1
(43) Pub. Date: Mar. 29, 2007

(54) Click fraud resistant learning of click through rate

(75) Inventors: Nicole S. Immorlica, Seattle, WA (US); Kamal Jain, Bellevue, WA (US); Mohammad Mahdian, Bellevue, WA (US); Kunal Talwar, San Francisco, CA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/234,476

(22) Filed: Sep. 23, 2005

(51) Int. Cl. G06Q 30/00

(52) U.S. Cl. 705/14

(57) ABSTRACT

Click-based algorithms are leveraged to provide protection against fraudulent user clicks of online advertisements. This enables mitigation of short term losses due to the fraudulent clicks and also mitigates long term advantages caused by the fraud. The techniques employed utilize “expected click wait” instead of CTR to determine the likelihood that a future click will occur. An expected click wait is based on the number of events that occur before a certain number of clicks are obtained. The events can also include advertisement impressions and/or sale and the like. This flexibility allows for fraud detection of other systems by transforming the other systems to clock-tick fraud based systems. Averages, including weighted averages, can also be utilized with the systems and methods herein to facilitate in providing a fraud resistant estimate of the CTR.

### BACKGROUND

Modem society has come to depend heavily on computers and computer technology. It is especially prevalent in the business arena where companies compete fiercely for customers and product sales. A company with just-in-time inventory and well focused advertising strategies generally produces a product cheaper and delivers it faster to a customer than a competitor. Computer technology makes this type of business edge possible by networking businesses, information, and customers together. Although originally computers communicated to other computers via networks that only consisted of local area networks (LANs), the advent of the Internet has allowed virtually everyone with a computer to participate in a global network. This allows small businesses to be competitive with larger businesses without having to finance and build a network structure.

As computing and networking technologies become more robust, secure and reliable, more consumers, wholesalers, retailers, entrepreneurs, educational institutions and the like are shifting paradigms and employing the Internet to perform business instead of the traditional means. Many businesses are now providing websites and on-line services. For example, today a consumer can access his/her account via the Internet and perform a growing number of available transactions such as balance inquiries, finds transfers and bill payment.

Moreover, electronic commerce has pervaded almost every conceivable type of business. People have come to expect that their favorite stores not only have brick and mortar business locations, but that they can also be accessed “online,” typically via the Internet's World Wide Web (WWW). The Web allows customers to view graphical representations of a business' store and products. Ease of use from the home and convenient purchasing methods, typically lead to increased sales. Buyers enjoy the freedom of being able to comparison shop without spending time and money to drive from store to store.

Advertising in general is a key revenue source in just about any commercial market or setting. To reach as many consumers as possible, advertisements are traditionally presented via billboards, television, radio, and print media such as newspapers and magazines. However, with the Internet, advertisers have found a new and perhaps less expensive medium for reaching vast numbers of potential customers across a large and diverse geographic span. Advertisements on the Internet can primarily be seen on web pages or websites as well as in pop-up windows when a particular site is visited.

In addition to such generic website advertising, businesses interested in finding new customers and generating revenues continue to look for atypical channels that may be suitable for posting advertisements. One alternate delivery mode, for example, involves attaching an advertisement to an incoming email for the recipient of the email to view. The type or subject matter of the advertisement may be selected according to text included in the body of the message.

Thus, global communication networks such as the Internet have presented commercial opportunities for reaching vast numbers of potential customers. In the past several years, large quantities of users have turned to the Internet as a reliable source of news, research resources, and various other types of information. In addition, online shopping, making dinner reservations, and buying concert and/or movie tickets are just a few of the common activities currently conducted while sitting in front of a computer by way of the Internet. However, the widespread use of the Internet by businesses as well as private consumers can lead to unwanted or even undesirable exposure to a variety of economic risks and/or security weaknesses.

With respect to online businesses, security and the validity of buyers making online purchases or reservations have become main concerns. For example, many restaurants provide an online reservation service wherein customers can make their reservations via the Internet using the restaurants' websites. Unfortunately, this system makes restaurant owners somewhat vulnerable to automated script attacks that make fraudulent reservations. Such attacks occur when a computer makes several hundred, if not more, fake online reservations affecting a large number of restaurants. As a result of such an attack, these businesses can be interrupted or even damaged due to loss revenues, system repairs and clean-up costs, as well as the expenses associated with improving network security.

Businesses that advertise can also be subject to such fraudulent attacks. Generally, a business is charged “per click” for their advertisement on a Web page. If a script or human workforce is utilized to “click” that advertisement several thousand times, the business is charged for those clicks even though they were fraudulent clicks. Competitors have an incentive to create these fraudulent clicks, which can drive the victim out of the competition for advertisement slots, and, in auction-based systems, lower the required winning bid. Click fraud is currently a substantial problem because it is not always possible to know if a click is legitimate or not.

When competitors fraudulently click on another business' advertisement, it initially depletes the business' advertising budget, creating a short term loss for the business. However, the number of clicks per showing of the advertisement (or “impression”) increases, allowing the business to bid less for future advertisements. Thus, there is a long term advantage to the fraudulent clicks for the business being attacked. The long term advantage, however, would not be beneficial to the business if the initial budget depletion causes the business to completely withdraw from future advertisement auctions because no additional monies remain. Thus, it is highly desirable to mitigate the short term losses by guarding against fraudulent advertisement clicks, regardless of the source or method utilized to implement the fraud.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

Systems and methods are provided for learning advertisement click through rates (CTRs) in a fraud resistant manner. Click-based algorithms are leveraged to provide protection against fraudulent user clicks of online advertisements. This enables mitigation of short term losses due to the fraudulent clicks and also mitigates long term advantages caused by the fraud. The techniques employed utilize an “expected event wait” instead of CTR to determine the likelihood that a future event will occur, or more precisely, the expected number of “trials” necessary before a future “event” occurs (e.g., when a clicked advertisement impression will occur). For example, an expected click wait is based on the number of impressions that occur before a certain number of clicks are obtained. The events can also include occurrences of advertisement impressions and/or sale and the like, and the trials can include an advertisement impression and/or a clock-tick. This flexibility allows for fraud detection of other systems by enabling transformation of the other systems to clock-tick fraud based systems which are inherently fraud resistant. Averages, including weighted averages, can also be utilized with the systems and methods herein to facilitate in providing a fraud resistant estimate of the CTR.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a fraud resistant event probability system in accordance with an aspect of an embodiment.

FIG. 2 is another block diagram of a fraud resistant event probability system in accordance with an aspect of an embodiment.

FIG. 3 is yet another block diagram of a fraud resistant event probability system in accordance with an aspect of an embodiment.

FIG. 4 is a block diagram of a fraud resistant auction system in accordance with an aspect of an embodiment.

FIG. 5 is a flow diagram of a method of facilitating fraud resistant event expectation advertisement data in accordance with an aspect of an embodiment.

FIG. 6 is another flow diagram of a method of facilitating fraud resistant event expectation advertisement data in accordance with an aspect of an embodiment.

FIG. 7 is a flow diagram of a method of facilitating fraud resistant online advertisement auctions in accordance with an aspect of an embodiment.

FIG. 8 is a flow diagram of a method of facilitating fraud resistant acquisition data for online advertisements in accordance with an aspect of an embodiment.

FIG. 9 illustrates an example operating environment in which an embodiment can be performed.

FIG. 10 illustrates another example operating environment in which an embodiment can be performed.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

In pay-per-click online advertising systems, advertisers are charged for their advertisements only when a user clicks on the advertisement. While these systems have many advantages over other methods of selling online advertisements, they suffer from one major drawback. They are highly susceptible to a particular style of fraudulent attack called click fraud. Click fraud happens when an advertiser and/or service provider generates clicks on an advertisement with the sole intent of increasing the payment of the advertiser. Leaders in the pay-per-click marketplace have identified click fraud as the most significant threat to their business model. Systems and methods herein employ a particular class of learning algorithms called click-based algorithms that are resistant to click fraud. A simple situational example (illustrated infra) in which there is just one advertisement slot can be utilized to show that fraudulent clicks cannot increase the expected payment per impression by more than a negligible amount in a click-based algorithm. Conversely, other common learning algorithms are vulnerable to fraudulent attacks.

For example, advertisers usually give their bids as a “per click value” along with a budget that they are willing to spend. A competing advertiser (Advertiser A) can deceivingly click another advertiser's (Advertiser B) advertisements to deplete the budget of the latter. This helps advertiser A in two ways. First, advertiser B's advertisement campaign becomes ineffective and hence B could not reach the potential customers which may now go to A. Second, B's advertiser's budget finishes quickly and hence B can no longer bid for advertisement slots. This means that A can get those advertisement slots cheaper. Hence, A can now get more customers with the same budget. Thus, click fraud is one of the biggest threats faced by the advertisement-auction market.

Some instances of the systems and methods herein utilize an expected click wait (ECW) instead of CTR in an advertisement-auction. The expected click wait can be statistically learned as described infra. A click fraud resistant learning formula balances out the one term charge of clicking with a repetitive benefit of paying lower because of a lower ECW. Thus, the learning of ECW is click fraud resistant. The traditional method of estimating the CTR does not have this property. In order to learn the ECW, instead of observing the number of clicks out of so many impressions, the number of impressions needed to wait to get so many clicks is counted. E.g., how many impressions it takes to produce 50 clicks. This new formula dampens the effect of clicks. It converts the click-fraud into impression-fraud. That is one fraudulent click has as much effect as one fraudulent impression, regardless of whether the impression is clicked or not. Each impression of an advertisement is worth significantly less than each click (a current estimate is that each impression is worth 1-2% points of each click). So an entity committing fraud has to create many more impressions which makes the detection of the fraudulent act easy.

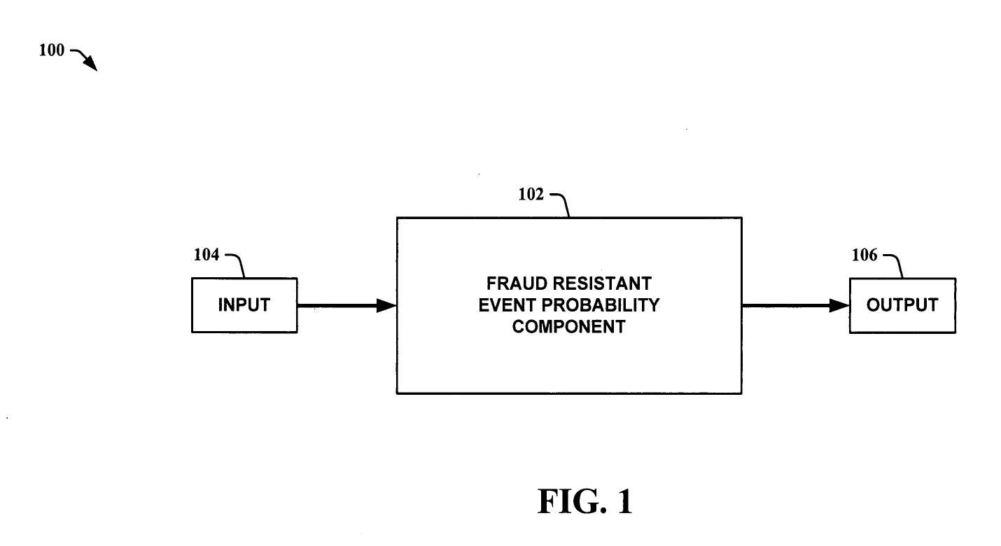

In FIG. 1, a block diagram of a fraud resistant event probability system 100 in accordance with an aspect of an embodiment is shown. The fraud resistant event probability system 100 is comprised of a fraud resistant event probability component 102 that receives an input 104 and provides an output 106. The input 104 typically includes data relating to events associated with an online advertisement. The events can include, for example, a clock-tick leading to an advertisement impression, an impression leading to a click, and/or an impression leading to an acquisition and the like. The clock-ticks can be based on a unit of time measure such as, for example, seconds, minutes, and/or hours and the like. The input 104 can also include relational information between events and/or time such as, for example, information that allows the determination of a number of non-clicked impressions before an occurrence of a clicked impression and the like. In general, the input 104 includes, but is not limited to, historical advertisement data that can be time dependent, impression dependent, and/or click dependent. The fraud resistant event probability component 102 employs the input 104 to facilitate in determining the occurrence likelihood of future events. It 102 accomplishes this via employment of click-based algorithms that are fraud resistant.

The fraud resistant event probability component 102 is flexible enough that it 102 can be utilized to convert different historical data dependencies to provide the output 106. By utilizing the fraud resistant algorithms, the predicted likelihood of the event occurring is fraud resistant as well. Thus, the output 106 is typically a fraud resistant expected event wait value that can be employed in advertisement auctions and the like to facilitate in establishing fraud resistant pricing structures for advertisers. The expected event wait can include, for example, expected click wait, and/or expected impression wait (EIW) (see infra) and the like.

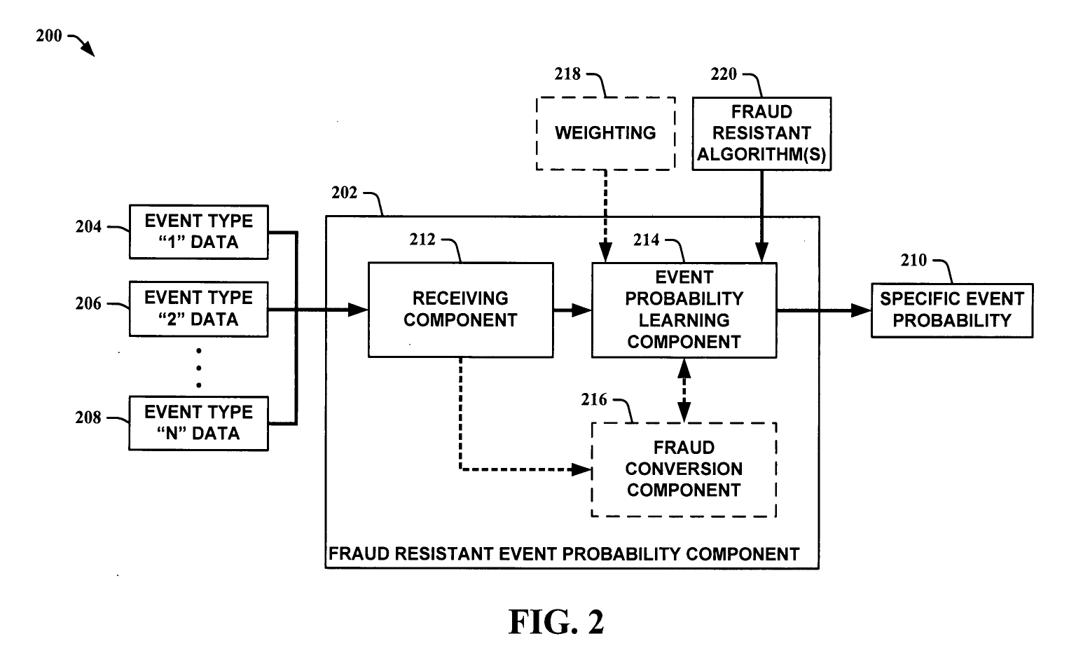

Looking at FIG. 2, another block diagram of a fraud resistant event probability system 200 in accordance with an aspect of an embodiment is depicted. The fraud resistant event probability system 200 is comprised of a fraud resistant event probability component 202 that receives event type “1-N” data 204-208, where “N” is an integer from one to infinity, and provides a specific event probability 210. The fraud resistant event probability component 202 is comprised of a receiving component 212, an event probability learning component 214, and an optional fraud conversion component 216. The event type “1-N” data 204-208 can include, but is not limited to, event type data such as, for example, non-clicked advertisement impression data, clicked advertisement impression data, and/or acquisition data associated with an advertisement and the like. The clicked advertisement impression data is essentially data related to an occurrence of a converted (e.g., “clicked”) impression. Thus, the clicked impression is a converted event of another event (e.g., impression occurrence). In a similar fashion, an acquisition can be construed to be a converted event in relation to a clicked impression (i.e., acquisitions typically occur after an impression has been clicked and a user makes a subsequent purchase).

The receiving component 212 obtains the event type “1-N” data 204-208 and provides it to the event probability learning component 214. Optionally, the event type “1-N” data 204-208 can be provided to the optional fraud conversion component 216 in place of providing it to the event probability learning component 214 or in addition to providing it to the event probability learning component 214. The event probability learning component 214 employs at least one fraud resistant algorithm 220 to facilitate in processing the event type “1-N” data 204-208. The fraud resistant algorithm 220 is a click-based algorithm. The event probability learning component 214 can also employ an optional weighting 218 to facilitate in learning the specific event probability 210. In some instances, the event probability learning component 214 can interact with the optional fraud conversion component 216 to facilitate in converting different types of fraud into a fraud resistant form. For example, acquisition fraud can be converted to clicked impression fraud then to non-clicked impression fraud and then to clock-tick fraud which is inherently fraud resistant. This allows substantial flexibility in the utility of the fraud resistant event probability system 200.

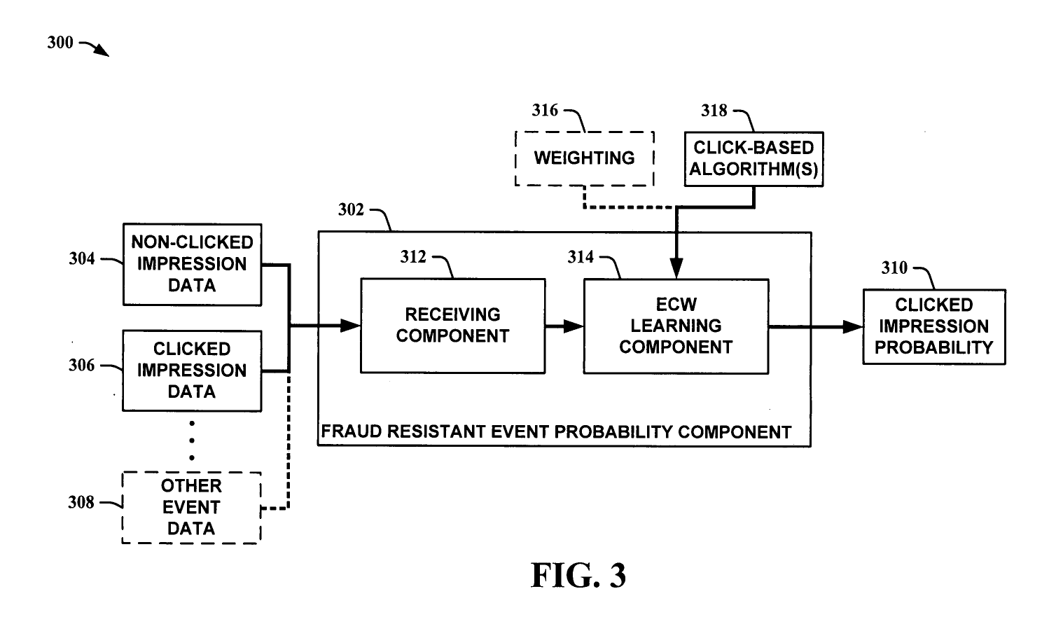

Turning to FIG. 3, yet another block diagram of a fraud resistant event probability system 300 in accordance with an aspect of an embodiment is illustrated. The fraud resistant event probability system 300 is comprised of a fraud resistant event probability component 302 that receives non-clicked impression data 304, clicked impression data 306, and/or optional other event data 308 and provides a clicked impression probability 310. The fraud resistant event probability component 302 is comprised of a receiving component 312 and an expected click weight (ECW) learning component 314. The receiving component 312 obtains non-clicked impression data 304, clicked impression data 306, and/or optional other event data 308. This data 304-308 is passed to the ECW learning component 314. The ECW learning component 314 utilizes at least one click based algorithm 318 to facilitate in learning a fraud resistant expected click wait. Optional weighting 316 of the input data 304-308 can also be employed by the ECW learning component 314 to facilitate in learning the expected click weight. The learned ECW is then provided as the clicked impression probability 310. The fraud resistant event probability system 300 can be utilized to provide click fraud resistant data to an advertisement auction system as described below.

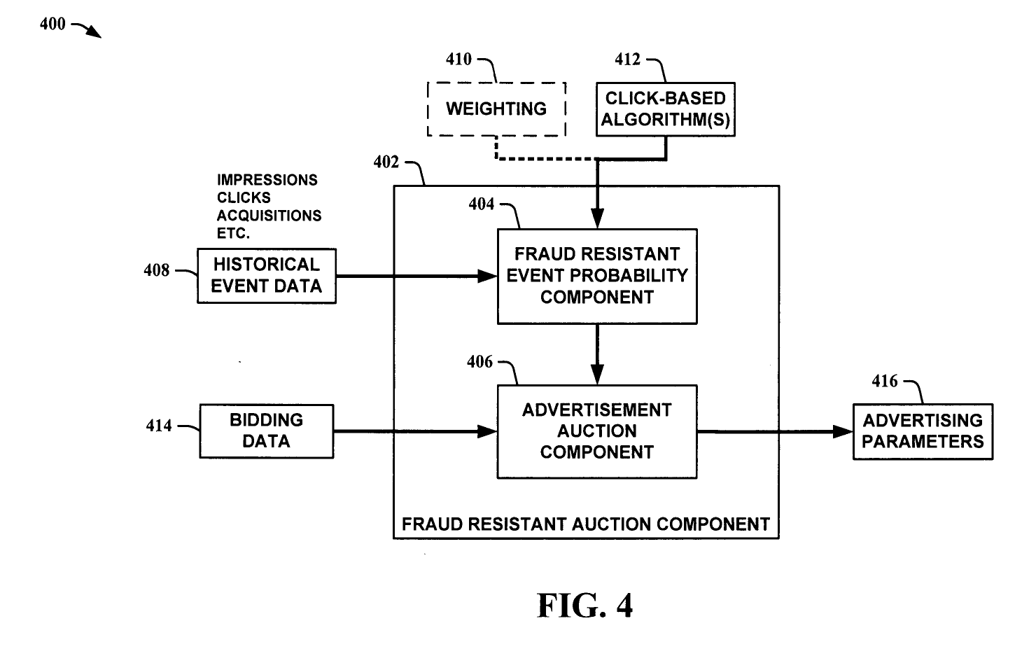

Moving on to FIG. 4, a block diagram of a fraud resistant auction system 400 in accordance with an aspect of an embodiment is shown. The fraud resistant auction system 400 is comprised of a fraud resistant auction component 402 that receives historical event data 408 and/or bidding data 414 and provides advertising parameters 416. The fraud resistant auction component 402 is comprised of a fraud resistant event probability component 404 and an advertisement auction component 406. The fraud resistant event probability component 404 obtains the historical event data 408 and employs at least one click-based algorithm to facilitate in determining an expected click wait. The historical event data 408 can include, but is not limited to, advertisement impression data, advertisement clicked impression data, and/or acquisition data associated with a clicked impression and the like. The fraud resistant event probability component 404 can also employ optional weighting 410 to facilitate in learning the expected click wait. The optional weighting 410 allows, for example, for more emphasis to be placed on recent event occurrences rather than older event occurrences in determination of the expected click wait.

The advertisement auction component 406 utilizes the learned expected click wait to facilitate in auctioning online advertisements and provide advertising parameters 416 based on bidding data 414. For example, the advertisement auction component 406 can utilize the inverse of the expected click wait in place of a traditional click through rate to determine the value of an impression, clicked impression, and/or acquisition to an advertiser that is bidding on an advertisement. Thus, the expected click wait provides a fraud resistant basis for utilizing prior historical data to predict future event occurrences such as, for example, the future likelihood that an impression will be clicked and/or an acquisition will be made. Thus, the advertising parameters 416 determined by the advertisement auction component 406 can include, but are not limited to, pricing for a particular advertiser for such events as impressions, clicks, and/or acquisitions and the like. By incorporating fraud resistance into the determination, an online advertisement auction can more fairly price events and/or substantially reduce competitor fraud and/or user abuse directed towards online advertisements. This is particularly important because of the manner in which the Internet operates.

The Internet is probably the most important technological creation of our times. It provides many immensely useful services to the masses for free, including such essentials as web portals, web email, and web search. These services are expensive to maintain and depend upon advertisement revenue to remain free. Many services generate advertisement revenue by selling advertisement clicks. In these pay-per-click systems, an advertiser is charged only when a user clicks on their advertisement.

Thus, a scenario of particular concern for service providers and advertisers in pay-per-click markets is clickfraud—the practice of gaming the system by creating fraudulent clicks, usually with the intent of increasing the payment of the advertiser. As each click can cost on the order of $1, it does not take many fraudulent clicks to generate a large bill. Just a million fraudulent clicks, perhaps generated by a simple script, can cost the advertiser $1,000,000, easily exhausting their budget. Fraudulent behavior threatens the very existence of the pay-per-click advertising market and has consequently become a subject of great concern (see, D. Mitchell, Click fraud and halli-bloggers, New York Times, Jul. 16, 2005; A. Penenberg, Click fraud threatens web, Wired News, Oct. 13, 2004; and B. Stone, When mice attack: Internet scammers steal money with ‘click fraud,’ Newsweek, Jan. 24, 2005).

A variety of proposals for reducing click fraud have surfaced. Most service providers currently approach the problem of click fraud by attempting to automatically recognize fraudulent clicks and discount them. Fraudulent clicks are recognized by machine learning algorithms which use information regarding the navigational behavior of users to try and distinguish between human and robot-generated clicks. Such techniques require large datasets to train the learning methods, have high classification error, and are at the mercy of the “wisdom” of the scammers. Recent tricks, like using inexpensive labor to generate these fraudulent clicks (see, N. Vidyasagar, India's secret army of online ad ‘clickers,’ The Times of India, May 3, 2004), make it virtually impossible to use these machine learning algorithms.

Another line of proposals attempts to reduce click fraud by removing the incentives for it. Each display of an advertisement is called an impression. Goodman (see, J. Goodman, Pay-per-percentage of impressions: an advertising method that is highly robust to fraud, Workshop on Sponsored Search Auctions, 2005) proposed selling advertisers a particular percentage of all impressions rather than user clicks. Similar proposals have suggested selling impressions. For a click-through-rates of 1%, the expected price per impression in the scenario mentioned above is just one cent. Thus, to force a payment of $1,000,000 upon the advertiser, 100,000,000 fraudulent impressions must be generated versus just 1,000,000 fraudulent clicks in the pay-per-click system. When such large quantities of fraud are required to create the desired effect, it ceases to be profitable to the scammer.

Although percentage and impression based proposals effectively eliminate fraud, they suffer from three major drawbacks. First, the developed industry standard sells clicks, and any major departure from this model risks a negative backlash in the marketplace. Second, by selling clicks, the service provider subsumes some of the risk due to natural fluctuations in the marketplace (differences between day and night or week and weekend, for example). Third, by requesting a bid per click, the service provider lessens the difficulty of the strategic calculation for the advertiser. Namely, the advertiser only needs to estimate the worth of a click, an arguably easier task than estimating the worth of an impression.

The systems and methods herein eliminate the incentives for click fraud for systems that sell clicks. A common pay-per-click system is utilized as an example which has been shown empirically to have higher revenue (see, J. Feng, H. K. Bhargava, and D. Pennock, Comparison of allocation rules for paid placement advertising in search engines, In Proceedings of the fifth International Conference on Electronic Commerce, Pittsburgh, Pa., USA, 2003 and Hemant Bhargava Juan Feng and David Pennock, Implementing paid placement in web search engines: Computational evaluation of alternative mechanisms, accepted by informs journal of computing to appear in the Informs Journal of Computing) than other pay-per-click systems (see, Advertiser workbook at http://searchmarketing.yahoo.com/rc/srch/eworkbook.pdf). This system is based on estimates of the click-through rate (CTR) of an advertisement. The CTR is defined as the likelihood, or probability, that an impression of an advertisement generates a click. In this system, each advertiser submits a bid which is the maximum amount the advertiser is willing to pay per click of the advertisement. The advertisers are then ranked based on the product of their bids and respective estimated CTRs of their advertisements. This product can be interpreted as an expected bid per impression. The advertisement space is allocated in the order induced by this ranking. Advertisers are charged only if they receive a click, and they are charged an amount inversely proportional to their CTR.

In pay-per-click systems, when a fraudulent click happens, an advertiser has to pay for it, resulting in a short term loss to the advertiser whose advertisement is being clicked fraudulently. However, in the system described above, there is a long term benefit too. Namely, a fraudulent click will be interpreted as an increased likelihood of a future click and so result in an increase in the estimate of the CTR. As the payment is inversely proportional to the CTR, this results in a reduction in the payment. If the short term loss and the long term benefit exactly cancel each other, then there will be less incentive to generate fraudulent clicks; in fact, a fraudulent click or impression will only cost the advertiser as much as a fraudulent impression in a pay-per-impression scheme. Whether this happens depends significantly on how the system estimates the CTRs. There are a variety of algorithms for this task. Some options include taking the fraction of all impressions so far that generated a click, or the fraction of impressions in the last hour that generated a click, or the fraction of the last hundred impressions that generated a click, or the inverse of the number of impressions after the most recent click, and so on.

The systems and methods herein employ a particular class of learning algorithms called click-based algorithms that have the property that the short term loss and long term benefit in fact cancel. Click-based algorithms are a class of algorithms whose estimates are based upon the number of impressions between clicks. To compute the current estimate, one click-based algorithm, for example, computes a weight for each impression based solely on the number of clicks after it and then takes the weighted average. An example of an algorithm in this class is one which outputs an estimate equal to the reciprocal of the number of impressions before the most recent click. Click-based algorithms satisfying additional technical assumptions are fraud-resistant in the sense that a devious user cannot change the expected payment of the advertiser per impression. In sharp contrast, traditional methods for estimating CTR (e.g, taking the average over a fixed number of recent impressions) are not fraud-resistant.

Additionally, instead of impressions leading to clicks, the events which are happening can be having an impression in a clock-tick as well. Sometimes, it is desirable to find the expected impression wait (EIW) (i.e., how many minutes are required to get so many impressions). The same theory can be utilized to convert impression-fraud into clock-tick-fraud which is inherently fraud resistant (altering time is inherently impossible). Hence, in principal, the click-fraud (and the impression fraud) can be completely eliminated. The click fraud can be converted into impression fraud which is then converted into clock-tick-fraud. This process also allows new business models. Businesses can now charge per acquisition. Some of the clicks are converted into acquisition, i.e., a paying customer for the advertiser. One problem in charging in terms of acquisition is that an advertiser may misreport the acquisitions. This is called acquisition-fraud. In principal, the acquisition fraud can be eliminated via converting it into click fraud, which in turn is converted into impression fraud and then to clock-tick fraud. Additionally, the processes can even be made more flexible. Instead of counting how many impressions it took to give us fifty clicks, a weighted average formula can be employed. For example, how many impressions it took the last click can have twice the weight than the number of impressions it took to get the click before the last. Averages, and even weighted averages, over the last fixed number of clicks can be used.

For example, an advertisement data set can include prior event happenings, e.g., impressions generated and events that are converted from these events into another type of event, e.g., some of the impressions were clicked by a user (non-clicked impressions converted into clicked impressions). Traditionally, the rate of conversion of non-clicked impressions into clicked impressions is determined (e.g., roughly what is the fraction of impressions converted into clicks). A traditional way of measuring this is to wait for some number of impressions and see how many of those impressions are converted into clicks. This is also called click through rate or simply “CTR.” If there are no fraudulent clicks then this traditional way of measuring CTR can suffice.

Oftentimes, there are fraudulent clicks and user clicks for an advertisement impression for some purpose other than a genuine interest in the advertisement. As explained supra, a user may just be an advertiser who is clicking the advertisements of a competing advertiser to deplete the budget of the latter. In some scenarios, a user may be an advertiser who is clicking their own advertisement to increase the CTR of their advertisement. A reason for doing this is that some of the existing advertisement-auction protocols charge inversely proportional to the CTR. So, if an advertisement has a higher CTR then not only is each click of an advertisement charged less, but also the advertisement is also shown at prime locations. Also, if CTR falls below a certain threshold then some advertisement-auction companies do not even consider the advertisement irrespective of the bids. So, there are many reasons for benefiting by artificially raising CTR. And of course there is an upfront cost, each click causes a charge.

Implementation Scenario

Consider a simple setting in which a service provider wishes to sell space for a single advertisement on a web page. There are a number of advertisers, each of whom wishes to display their advertisement on the web page. The service provider sells the advertisement space according to the pay-per-click model and through an auction: the advertiser whose advertisement is displayed is charged only when a user clicks on his advertisement. Each advertiser i submits a bid bᵢ indicating the maximum amount they are willing to pay the service provider when a user clicks on their advertisement. The allocation and price is computed using the mechanism described below.

For each advertisement, the service provider estimates the probability that the advertisement receives a click from the user requesting the page if it is displayed. This probability is called the click-through-rate (CTR) of the advertisement. Each bid bᵢ is multiplied by the estimate λᵢ of the CTR of the advertisement. The product λᵢbᵢ thus represents the expected willingness-to-pay of advertiser i per impression. The slot is awarded to the advertiser i* with the highest value of λᵢbᵢ. If the user indeed clicks on the advertisement, then the winning advertiser is charged a price equal to the second highest λᵢbᵢ divided by theirs (that is, the winner's) estimated CTR (that is, λᵢ.). Thus, if advertisers are labeled such that λᵢbᵢ>λᵢ₊₁bᵢ₊₁, then the slot is awarded to advertiser 1 and, upon a click, they are charged a price λ₂b₂/λ₁. This mechanism is evaluated over a period of time during which the same advertiser wins the auction, and the value of λ₂b₂ does not change. If the advertisers do not change their bids too frequently and λ₁b₁ and λ₂b₂ are not too close to each other, it is natural to expect this to happen most of the time. Thus, henceforth, focus will be on the winner of the auction, defining p:=λ₂b₂ and λ:=λ₁.

CTR Learning Algorithms

The method by which the algorithm learns the CTRs have been left unspecified. There are a variety of different algorithms one could utilize for learning the CTR of an advertisement. Some simple examples, described below, include averaging over time, impressions, and/or clicks, as well as exponential discounting.
Average over fixed time window: For a parameter T, let x be the number of clicks received during the last T time units and y be the number of impressions during the last T time units. Then λ=x/y.
Average over fixed impression window: For a parameter y, let x be the number of clicks received during the last y impressions. Then λ=x/y.
Average over fixed click window: For a parameter x, let y be the number of impressions since the x'th last click. Then λ=x/y.
Exponential discounting: For a parameter α, let e^{-ai} be a discounting factor used to weight the i'th most recent impression. Take a weighted average over all impressions, that is, Σᵢxᵢe^{-ai}/Σᵢe^{-ai} where xᵢ is an indicator variable that the i'th impression resulted in a click.

These algorithms are all part of a general class defined infra. The algorithm estimates the CTR of the advertisement for the current impression as follows: Label the previous impressions, starting with the most recent, by 1, 2, . . . . Let tᵢ be the amount of time that elapsed between impression i and impression 1, and cᵢ be the number of impressions that received clicks between impression i and impression 1 (impressions 1 included). The learning algorithms of interest are defined by a constant γ and a function δ(tᵢ,i,cᵢ) which is decreasing in all three parameters. This function can be thought of as a discounting parameter, allowing the learning algorithm to emphasize recent history over more distant history. Let xᵢ be an indicator variable for the event that the i'th impression resulted in a click. The learning algorithm then computes:

$$λ = \frac{{\sum }_{i = 1}^{∞} {x}_{i} δ ( {t}_{i} , i , {c}_{i} ) + γ}{{\sum }_{i = 1}^{∞} {x}_{i} δ ( {t}_{i} , i , {c}_{i} ) + γ} .$$

The constant γ is often a small constant that is used to guarantee that the estimated click-through-rate is strictly positive and finite. Notice that in the above expression, the summation is for every i from 1 to ∞. This is ambiguous, since the advertiser has not been always present in the system. To remove this ambiguity, the algorithm assumes a default infinite history for every advertiser that enters the system. This default sequence could be a sequence of impressions all leading to clicks, indicating that the newly arrived advertiser is initialized with a CTR equal to one, or (as it is often the case in practice) it could be a sequence indicating a system-wide default initial CTR for new advertisers. For most common learning algorithms, the discount factor becomes zero or very small for far distant history, and hence the choice of the default sequence only affects the estimate of the CTR at the arrival of a new advertiser. Note that all three learning methods discussed above are included in this class (for γ=0).
Average over fixed time window: The function δ(tᵢ,i,cᵢ) is 1 if tᵢ≦T and 0 otherwise.
Average over fixed impression window: The function δ(tᵢ,i,cᵢ) is 1 if i≦y and 0 otherwise.
Average over fixed click window: The function δ(tᵢ,i,cᵢ) is 1 if cᵢ≦x and 0 otherwise.
Exponential discounting: The function δ(tᵢ,i,cᵢ) is e^{-ai}.
   Fraud Resistance

For each of the methods listed above, for an appropriate setting of parameters (e.g., large enough y in the second method), on a random sequence generated from a constant CTR, the estimate computed by the algorithm gets arbitrarily close to the true CTR, and so it is not á priori apparent which method is preferred. Furthermore, when the learning algorithm computes the true CTR, the expected behavior of the system is essentially equivalent to a pay-per-impression system, with substantially reduced incentives for fraud. This might lead to the conclusion that all of the above algorithms are equally resistant to click fraud. However, this conclusion is incorrect, as the scammer can sometimes create fluctuations in the CTR, thereby taking advantage of the failure of the algorithm to react quickly to the change in the CTR to harm the advertiser.

The definition of fraud resistance is motivated by the way various notions of security are defined in cryptography: the expected amount the advertiser has to pay in two scenarios is compared, one based on a random sequence generated from a constant CTR without any fraud, and the other with an adversary who can change a fraction of the outcomes (click vs. no-click) on a similar random sequence. Any scenario can be described by a time-stamped sequence of the outcomes of impressions (i.e., click or no-click). More precisely, if a click is denoted by 1 and a no-click by 0, the scenario can be described by a doubly infinite sequence s of zeros and ones, and a doubly infinite increasing sequence t of real numbers indicating the time stamps (the latter sequence is irrelevant if the learning algorithm is time-independent). The pair (s,t) indicates a scenario where the i'th impression (i can be any integer, positive or negative) occurs at time tᵢ and results in a click if and only if sₜ=1.
Definition 1: Let ε be a constant between zero and one, and (s,t) be a scenario generated at random as follows: the outcome of the i^{th} impression, sᵢ, is 1 with an arbitrary fixed probability λ and 0 otherwise, and the time difference tᵢ−tᵢ₋₁, between two consecutive impressions is drawn from a Poisson distribution with an arbitrary fixed mean. For a value of n, let (s′,t′) be a history obtained from (s,t) by letting an adversary insert at most εn impressions after the impression indexed 0 in (s,t). The history (s′,t′) is indexed in such a way that impression 0 refers to the same impression in (s,t) and (s′,t′). A CTR learning algorithm is ε-fraud resistant if for every adversary, the expected average payment of the advertiser per impression during the impressions indexed 1, . . . , n in scenario (s′,t′) is bounded by that of scenario (s,t), plus an additional term that tends to zero as n tends to infinity (holding everything else constant). More precisely, if qⱼ (q′ⱼ, respectively) denotes the payment of the advertiser for the j th impression in scenario (s,t) ((s′,t′), respectively), then the algorithm is ε-fraud resistant if for every adversary:

$$E [ \frac{1}{n} {\sum }_{j = 1}^{n} {q}_{j}^{′} ] \leq E [ \frac{1}{n} {\sum }_{j = 1}^{n} {q}_{j} ] + o ( 1 ) .$$

Intuitively, in a fraud-resistant algorithm, a fraudulent click or impression only costs the advertiser as much as a fraudulent impression in a pay-per-impression scheme. Some details are not elaborated on in the above definition. In particular, how much knowledge the adversary possesses is not specified. In practice, an adversary probably can gain knowledge about some statistics of the history, but not the complete history. However, techniques provided herein even hold for an all powerful adversary that knows the whole sequence (even the future) in advance, and prove that even for such an adversary, there are simple learning algorithms that are fraud-resistant. Many learning algorithms are not fraud-resistant even if the adversary only knows about the learning algorithm and the frequency of impressions in the scenario.

The assumption that the true click-through rate λ is a constant in the above definition is merely a simplifying assumption. In fact, results of the techniques described herein hold (with the same proof) even if the parameter λ changes over time, as long as the value of λ at every point is at least a positive constant (i.e., does not get arbitrarily close to zero). Also, the choice of the distribution for the time stamps in the definition is arbitrary, as the technique's positive result only concerns CTR learning algorithms that are time-independent, and the technique's negative result infra can be adapted to any case where the time stamps come from an arbitrary known distribution.

The CTR learning algorithms for which the discounting factor, δ, depends only on the number of impressions in the history which resulted in clicks (that is the parameter cᵢ defined above (and not on i and tᵢ)), are fraud-resistant. Such algorithms are denoted as click-based algorithms.
Definition 2: A CTR learning algorithm is click-based if δ(tᵢ,i,cᵢ)=δ(cᵢ) for some decreasing function δ(.).
   Of the schemes listed supra, it is apparent that only averaging over clicks is click-based. Intuitively, a click-based algorithm estimates the CTR by estimating the Expected Click-Wait (ECW), the number of impressions it takes to receive a click.
   Non-Click-Based Algorithms

In many simple non-click-based algorithms (such as averaging over fixed time window or impression window presented supra), an adversary can use a simple strategy to increase the average payment of the advertiser per impression. The learning algorithm that takes the average over a fixed impression window is presented as an example. It is easy to see that a similar example exists for averaging over a fixed time window.

Consider a history defined by setting the outcome of each impression to click with probability λ for a fixed λ. Denote this sequence by s. Consider the algorithm that estimates the CTR by the number of click-throughs during the past l impressions plus a small constant γ divided by l+γ, for a fixed l. If l is large enough and γ is small but positive, the estimate provided by the algorithm is often very close to λ, and, therefore, the average payment per impression on any interval of length n is arbitrarily close to p. Thus, an adversary can increase the average payment by a non-negligible amount.

Pay-Per-Acquisition Marketplaces

The supra discussion focuses on pay-per-click marketplaces. The reasoning for this is three-fold: it is a common industry model, it absorbs risk due to market fluctuations for the advertiser, and it simplifies the strategic calculations of the advertiser. The latter two of these points can be equally employed to argue the desirability of a pay-per-acquisition marketplace. In these marketplaces, a service provider receives payment from an advertiser only when a click resulted in a purchase. Such systems are used, for example, to sell books on web pages: a service provider can list an advertisement for a travel guide with the understanding that, should a user purchase the product advertised, then the service provider will receive a payment. The problem with pay-per-acquisition systems is that the service provider must trust the advertiser to truthfully report those clicks which result in acquisitions.

In a simple scenario with a single advertisement slot, click-based algorithms are fraud-resistant in the sense that the expected payment per impression of an advertiser cannot be increased by click fraud schemes. In fact, it can also be shown that this payment cannot be decreased either. Thus, as click-based learning algorithms reduce fraud in pay-per-click systems, acquisition-based learning algorithms induce truthful reporting in pay-per-acquisition systems.

Computational Considerations

The click-based learning algorithms eliminate click fraud. However, in order to be practical and implementable, learning algorithms should also be easily computed with constant memory. The computability of a click-based algorithm depends on the choice of the algorithm. Consider, for example, a simple click-based exponentially-weighted algorithm with δ(i)=e^{-ai}. Just two numbers are needed to compute this estimate: the estimate of the click-through rate for the most recent impression that leads to a click and a counter representing the number of impressions since the last click. However, other click-based algorithms have more computational issues. Consider an algorithm in which δᵢε{0,1} with εᵢ=1 if and only if i≦l for some (possibly large) l. Then at least l numbers must be recorded to compute this estimate exactly.

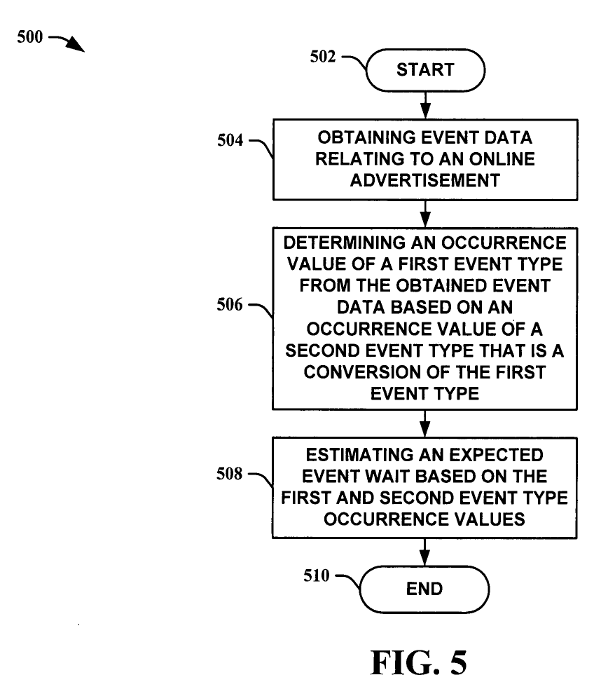

In view of the exemplary systems shown and described above, methodologies that may be implemented in accordance with the embodiments will be better appreciated with reference to the flow charts of FIGS. 5-8. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 5, a flow diagram of a method 500 of facilitating fraud resistant event expectation advertisement data in accordance with an aspect of an embodiment is shown. The method 500 starts 502 by obtaining event data relating to an online advertisement 504. The event data can include, but is not limited to, historical data associated with an online advertisement such as, for example, impression data, clicked impression data, and/or acquisition data related to an impression and the like. An occurrence value of a first event type is then determined from the obtained event data based on an occurrence value of a second event type that is a conversion of the first event type 506. For example, a first event type can be an advertisement impression. If a user clicks on the advertisement impression, it is converted into a clicked impression (i.e., a “clicked impression” is a conversion of a “non-clicked impression”). Thus, for example, a value of 50 clicked impressions can be established as the basis for determining an occurrence value of the number of impressions that occurred before the 50^{th} clicked impression was reached. Likewise, an event type such as an acquisition is a conversion of a clicked impression (a user clicks on an impression and then proceeds to purchase an item, service, etc.). Thus, in a similar fashion, for example, a value of 50 acquisitions can be established as the basis for determining an occurrence value of the number of clicked impressions that occurred before the 50^{th} acquisition was reached.

An expected event wait is then estimated based on the first and second event type occurrence values 508, ending the flow 510. For example, if the expected wait is based on clicked impressions, then an expected click wait (ECW) is determined based on the number of impressions that occurred before a predetermined number of clicked impressions occurred. If the expected wait is based on non-clicked impressions, then an expected impression wait (EIW) is determined based on the number of events that occur before a predetermined number of non-clicked impressions occurred. The expected event wait can be employed in advertisement auctions to facilitate in establishing future expected likelihoods of various event types for a given advertisement.

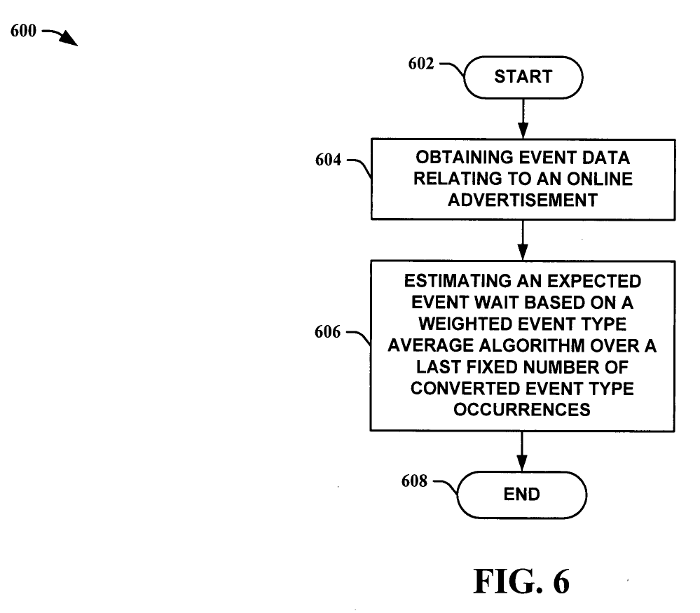

Referring to FIG. 6, another flow diagram of a method 600 of facilitating fraud resistant event expectation advertisement data in accordance with an aspect of an embodiment is depicted. The method 600 starts 602 by obtaining event data relating to an online advertisement 604. The event data can include, but is not limited to, historical data associated with an online advertisement such as, for example, impression data, clicked impression data, and/or acquisition data related to an impression and the like. An expected event wait is then estimated based on a weighted event type average algorithm over a last fixed number of converted event type occurrences 606, ending the flow 608. To facilitate in quickly ascertaining probabilities of an event occurring, weighting can be employed such that, for example, more recent events are given a higher weight than older events. For example, the 20 impressions that occurred before the most recent clicked impression can be waited more heavily than the 100 impressions that occurred before the second most recent click. The weighted values can then be averaged to facilitate in learning an expected event wait.

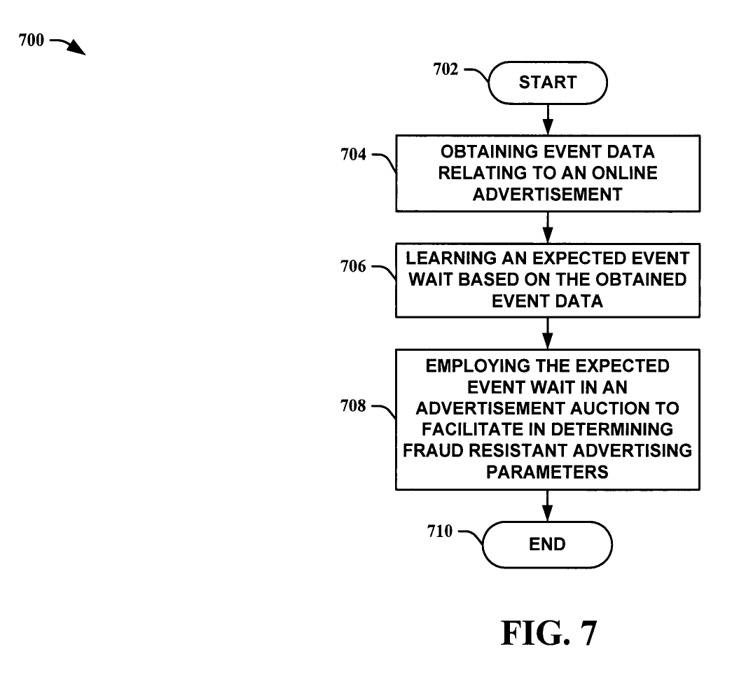

Looking at FIG. 7, a flow diagram of a method 700 of facilitating fraud resistant online advertisement auctions in accordance with an aspect of an embodiment is illustrated. The method 700 starts 702 by obtaining event data relating to an online advertisement 704. The event data can include, but is not limited to, historical data associated with an online advertisement such as, for example, impression data, clicked impression data, and/or acquisition data related to an impression and the like. An expected event wait is then learned based on the obtained event data 706. Various event types can be utilized along with various processes to facilitate in learning the expected event wait as described supra. The expected event wait is then employed in an advertisement auction to facilitate in determining fraud resistant advertising parameters 708, ending the flow 710. Utilization of fraud resistant expected event wait substantially enhances the value of the advertisement auction. It facilitates to ensure that short term losses and long term gains caused by fraud are mitigated and increases the trustworthiness of the auction process.

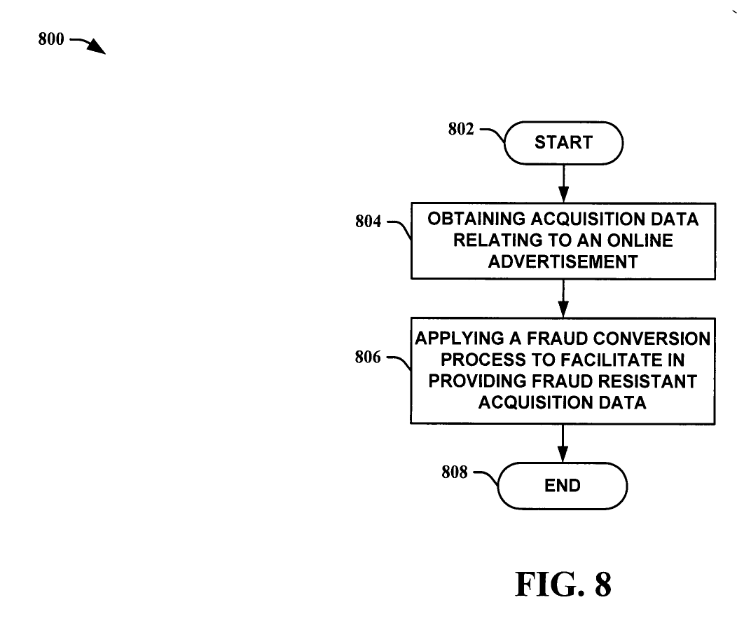

Turning to FIG. 8, a flow diagram of a method 800 of facilitating fraud resistant acquisition data for online advertisements in accordance with an aspect of an embodiment is shown. The method 800 starts 802 by obtaining acquisition data relating to an online advertisement 804. For example, the data can include number of acquisitions, timing information, and/or related events (e.g., number of clicked impressions, etc.) and the like. A fraud conversion process is then applied to facilitate in providing fraud resistant acquisition data 806, ending the flow 808. A general fraud conversion process for acquisition fraud includes, but is not limited to, first converting the acquisition fraud into click fraud, then into impression fraud, and then into clock-tick fraud. Clock-tick fraud is inherently difficult to accomplish and, therefore, facilitates in resisting acquisition fraud attempts by advertisers and the like.

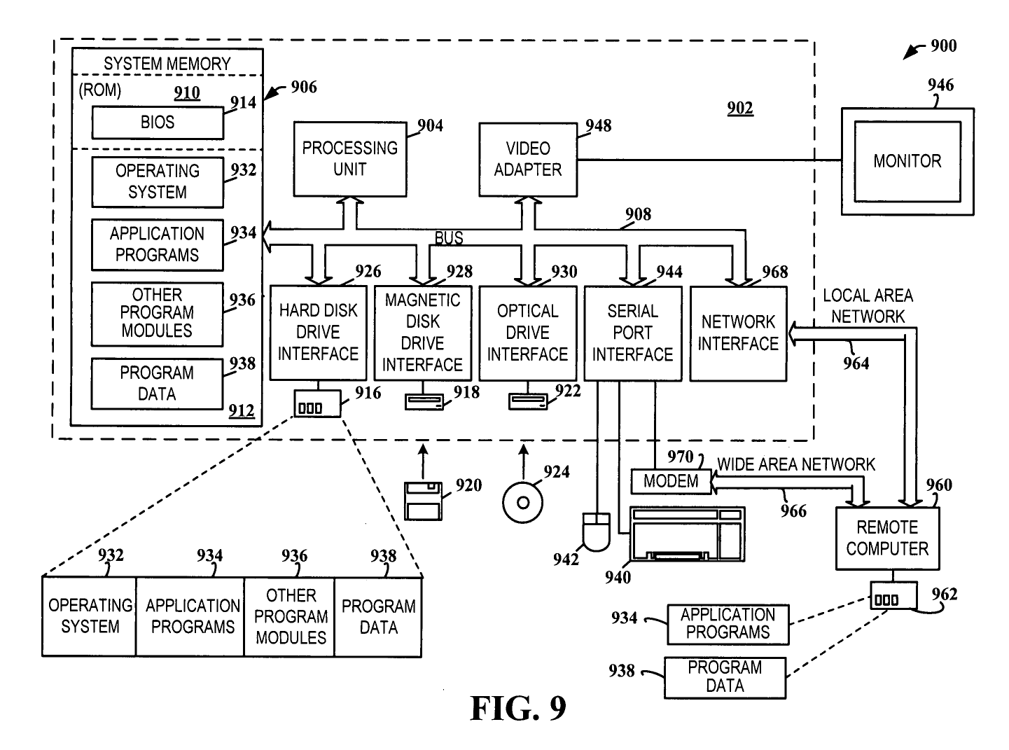

In order to provide additional context for performing various aspects of the embodiments, FIG. 9 and the following discussion is intended to provide a brief, general description of a suitable computing environment 900 in which the various aspects of the embodiments can be performed. Moreover, those skilled in the art will appreciate that the supra methods can be practiced with other computer system configurations, including single-processor or multi-processor computer systems, minicomputers, mainframe computers, as well as personal computers, hand-held computing devices, microprocessor-based and/or programmable consumer electronics, and the like, each of which can communicate with one or more associated devices. The illustrated aspects of the embodiments can also be practiced in distributed computing environments where certain tasks are performed by remote processing devices that are linked through a communications network. However, some, if not all, aspects of the embodiments can be practiced on stand-alone computers. In a distributed computing environment, program modules can be located in local and/or remote memory storage devices.

As used in this application, the term “component” is intended to refer to a computer-related entity, either hardware, a combination of hardware and software, software, or software in execution. For example, a component can be, but is not limited to, a process running on a processor, a processor, an object, an executable, a thread of execution, a program, and a computer. By way of illustration, an application running on a server and/or the server can be a component. In addition, a component can include one or more subcomponents.

With reference to FIG. 9, an exemplary system environment 900 for performing the various aspects of the embodiments include a conventional computer 902, including a processing unit 904, a system memory 906, and a system bus 908 that couples various system components, including the system memory, to the processing unit 904. The processing unit 904 can be any commercially available or proprietary processor. In addition, the processing unit can be implemented as multi-processor formed of more than one processor, such as can be connected in parallel.

The system bus 908 can be any of several types of bus structure including a memory bus or memory controller, a peripheral bus, and a local bus using any of a variety of conventional bus architectures such as PCI, VESA, Microchannel, ISA, and EISA, to name a few. The system memory 906 includes read only memory (ROM) 910 and random access memory (RAM) 912. A basic input/output system (BIOS) 914, containing the basic routines that help to transfer information between elements within the computer 902, such as during start-up, is stored in ROM 910.

The computer 902 also can include, for example, a hard disk drive 916, a magnetic disk drive 918, e.g., to read from or write to a removable disk 920, and an optical disk drive 922, e.g., for reading from or writing to a CD-ROM disk 924 or other optical media. The hard disk drive 916, magnetic disk drive 918, and optical disk drive 922 are connected to the system bus 908 by a hard disk drive interface 926, a magnetic disk drive interface 928, and an optical drive interface 930, respectively. The drives 916-922 and their associated computer-readable media provide nonvolatile storage of data, data structures, computer-executable instructions, etc. for the computer 902. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 900, and further that any such media can contain computer-executable instructions for performing the methods of the embodiments.

A number of program modules can be stored in the drives 916-922 and RAM 912, including an operating system 932, one or more application programs 934, other program modules 936, and program data 938. The operating system 932 can be any suitable operating system or combination of operating systems. By way of example, the application programs 934 and program modules 936 can include a fraud resistant online advertisement data expectation scheme in accordance with an aspect of an embodiment.

A user can enter commands and information into the computer 902 through one or more user input devices, such as a keyboard 940 and a pointing device (e.g., a mouse 942). Other input devices (not shown) can include a microphone, a joystick, a game pad, a satellite dish, a wireless remote, a scanner, or the like. These and other input devices are often connected to the processing unit 904 through a serial port interface 944 that is coupled to the system bus 908, but can be connected by other interfaces, such as a parallel port, a game port or a universal serial bus (USB). A monitor 946 or other type of display device is also connected to the system bus 908 via an interface, such as a video adapter 948. In addition to the monitor 946, the computer 902 can include other peripheral output devices (not shown), such as speakers, printers, etc.

It is to be appreciated that the computer 902 can operate in a networked environment using logical connections to one or more remote computers 960. The remote computer 960 can be a workstation, a server computer, a router, a peer device or other common network node, and typically includes many or all of the elements described relative to the computer 902, although for purposes of brevity, only a memory storage device 962 is illustrated in FIG. 9. The logical connections depicted in FIG. 9 can include a local area network (LAN) 964 and a wide area network (WAN) 966. Such networking environments are commonplace in offices, enterprise-wide computer networks, intranets and the Internet.

When used in a LAN networking environment, for example, the computer 902 is connected to the local network 964 through a network interface or adapter 968. When used in a WAN networking environment, the computer 902 typically includes a modem (e.g., telephone, DSL, cable, etc.) 970, or is connected to a communications server on the LAN, or has other means for establishing communications over the WAN 966, such as the Internet. The modem 970, which can be internal or external relative to the computer 902, is connected to the system bus 908 via the serial port interface 944. In a networked environment, program modules (including application programs 934) and/or program data 938 can be stored in the remote memory storage device 962. It will be appreciated that the network connections shown are exemplary and other means (e.g., wired or wireless) of establishing a communications link between the computers 902 and 960 can be used when carrying out an aspect of an embodiment.

In accordance with the practices of persons skilled in the art of computer programming, the embodiments have been described with reference to acts and symbolic representations of operations that are performed by a computer, such as the computer 902 or remote computer 960, unless otherwise indicated. Such acts and operations are sometimes referred to as being computer-executed. It will be appreciated that the acts and symbolically represented operations include the manipulation by the processing unit 904 of electrical signals representing data bits which causes a resulting transformation or reduction of the electrical signal representation, and the maintenance of data bits at memory locations in the memory system (including the system memory 906, hard drive 916, floppy disks 920, CD-ROM 924, and remote memory 962) to thereby reconfigure or otherwise alter the computer system's operation, as well as other processing of signals. The memory locations where such data bits are maintained are physical locations that have particular electrical, magnetic, or optical properties corresponding to the data bits.

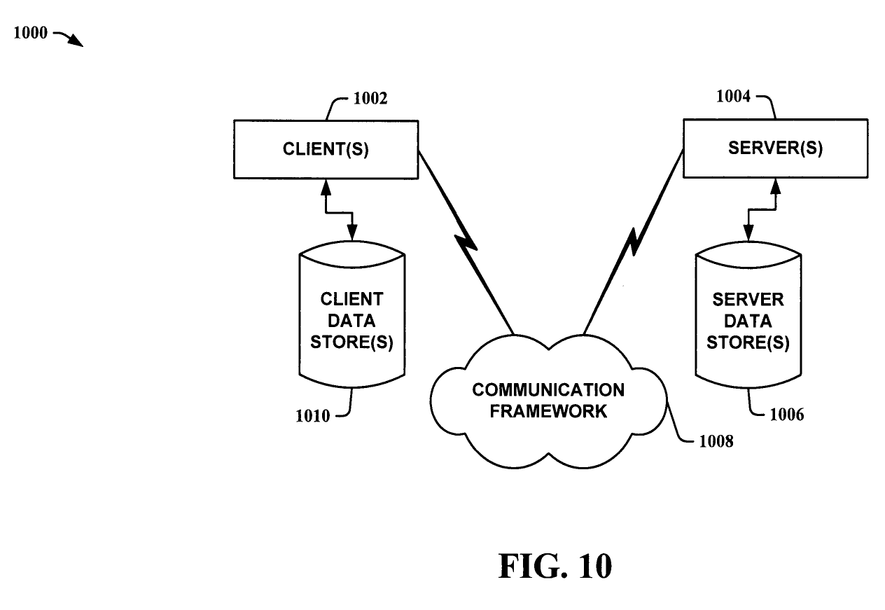

FIG. 10 is another block diagram of a sample computing environment 1000 with which embodiments can interact. The system 1000 further illustrates a system that includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). One possible communication between a client 1002 and a server 1004 can be in the form of a data packet adapted to be transmitted between two or more computer processes. The system 1000 includes a communication framework 1008 that can be employed to facilitate communications between the client(s) 1002 and the server(s) 1004. The client(s) 1002 are connected to one or more client data store(s) 1010 that can be employed to store information local to the client(s) 1002. Similarly, the server(s) 1004 are connected to one or more server data store(s) 1006 that can be employed to store information local to the server(s) 1004.

It is to be appreciated that the systems and/or methods of the embodiments can be utilized in fraud resistant online advertisement data facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates online advertisement data predictions, comprising:
a receiving component that receives at least one event data set relating to an online advertisement; and
a probability component that determines an occurrence value of a first event type from the obtained event data based on an occurrence value of a second event type from the obtained event data that is a conversion of the first event type and learns an expected event wait based on the first and second event type occurrence values.

2. The system of claim 1, the event type comprising a non-clicked advertisement impression, a clicked advertisement impression, and/or an acquisition relating to an advertisement.

3. The system of claim 1, the first event type comprising a non-clicked advertisement impression, the second event type comprising a clicked advertisement impression, and the expected event wait comprising an expected click wait.

4. The system of claim 3, the probability component employs click-based processes to facilitate in learning the expected click wait.

5. The system of claim 1, the probability component employs an averaging process to facilitate in learning the expected event wait.

6. The system of claim 5, the averaging process comprising a weighted averaging process over a last fixed number of converted event type occurrences.

7. An advertisement auction system that employs the system of claim 1 to facilitate in determining advertising parameters.

8. An advertisement auction system that employs the system of claim 1 to mitigate the effects of click fraud, impression fraud, and/or acquisition fraud.

9. A method for facilitating online advertisement data predictions, comprising:
receiving at least one event data set relating to an online advertisement; and
learning an expected wait of an event from the event data set via integration of the learning over a past fixed number of events.

10. The method of claim 9, the expected event wait comprising an expected click wait.

11. The method of claim 10 further comprising:
utilizing the expected click wait instead of a click through rate to facilitate in establishing a predicted click probability of an online advertisement.

12. The method of claim 9 further comprising:
employing the expected event wait in an advertisement auction to facilitate in determining advertising parameters.

13. The method of claim 9 further comprising:
employing the expected event wait to facilitate in mitigating effects of click fraud, impression fraud, and/or acquisition fraud.

14. The method of claim 9 further comprising:
determining an occurrence value of a first event type from the obtained event data based on an occurrence value of a second event type from the obtained event data that is a conversion of the first event type; and
learning the expected event wait based on the first and second event type occurrence values.

15. The method of claim 9 further comprising:
learning the expected event wait utilizing an averaging process over a last fixed number of an event occurrence.

16. The method of claim 15, the averaging process comprising a weighted averaging process.

17. A pay-per-acquisition advertisement auction method that employs the method of claim 9.

18. A method of auctioning online advertisements, comprising:
employing an expected click wait to facilitate in determining a likelihood of a future click on an advertisement impression by a user; and
utilizing the likelihood to facilitate in determining a pricing structure to charge an advertiser for each future click of the advertisement impression.

19. The method of claim 18 further comprising:
employing the expected click wait to facilitate in learning an expected acquisition rate associated with an advertisement impression; and
utilizing the expected acquisition rate to facilitate in determining a pay-per-acquisition pricing structure for an advertiser.

20. A device employing the method of claim 9 comprising at least one selected from the group consisting of a computer, a server, and a handheld electronic device.
